(19) United States
(12) Patent Application Publication
(10) Pub. No.: US 2026/0222668 A1
(43) Pub. Date: Jul. 30, 2026

(54) SYSTEM AND METHODS FOR FIBER-BASED LASER SPECKLE IMAGING

(71) Applicant: BOARD OF REGENTS, THE UNIVERSITY OF TEXAS SYSTEM, Austin, TX (US)

(72) Inventors: Andrew K. DUNN, Austin, TX (US); Christopher James SMITH, Austin, TX (US); Qingwei FANG, Austin, TX (US)

(21) Appl. No.: 19/145,173

(22) PCT Filed: Jan. 2, 2024
(86) PCT No.: PCT/US2024/010042

§ 371 Date: Jul. 1, 2025

Related U.S. Application Data
(60) Provisional application No. 63/478,264, filed on Jan. 3, 2023.

(51) Int. Cl. H04N 23/56; H04N 23/55; H04N 23/74

(52) U.S. Cl. CPC H04N 23/56; H04N 23/55; H04N 23/74

(57) ABSTRACT

An illumination system for laser speckle imaging includes a laser light source, two or more sections of optical fiber, a fiber-coupled acousto-optic modulator (FCAOM) that is coupled to the light source by a first section of the two or more sections of optical fiber, and a collimating optic that focuses light output by the laser to illuminate a subject within afield of view (FOV), where the collimating optic is coupled to the FCAOM by a second section of the two or more sections of optical fiber. In some implementations, the illumination system is incorporated into a laser speckle imaging system that includes an image capture device for capturing images of the subject within the FOV. In some implementations, the images are captured and processed using within-exposure modulated speckle imaging techniques.

### CROSS-REFERENCE TO RELATED APPLICATIONS

This application claims priority to and the benefit of U.S. Provisional Patent App. No. 63/478,264, filed Jan. 3, 2023, which is incorporated herein by reference in its entirety.

### STATEMENT REGARDING FEDERALLY SPONSORED RESEARCH OR DEVELOPMENT

This invention was made with government support under Grant no. R01 EB011556 and Grant no. R01 NS108484 awarded by the National Institutes of Health. The government has certain rights in the invention.

### BACKGROUND

Monitoring cerebral blood flow (CBF) plays an important role in a myriad of neurosurgical and neuroscience applications. In the operating room, applications of CBF monitoring range from tumor resections, cerebral artery bypasses, arteriovenous malformation (AVM) removals, and the microvascular clipping of cerebral aneurysms. In neuroscience and preclinical studies, CBF monitoring can play a large role in understanding the effects of stroke and stroke recovery. Numerous imaging techniques are available for monitoring CBF, ranging from optical techniques such as indocyanine green angiography (ICGA) to radiography techniques such as digital subtraction angiography (DSA); however, these techniques suffer from requiring contrast agents, a disruption to a surgical procedure if used intraoperatively, and require radiation exposure in the case of DSA.

Laser speckle contrast imaging (LSCI) has emerged as a powerful technique for continuously imaging CBF without use of a contrast agent. LSCI has been applied to both studying stroke and a variety of surgical and neurosurgical applications. LSCI is a label-free optical technique that can provide continuous monitoring of CBF using simple instrumentation. However, LSCI suffers from several drawbacks that limits its impact in quantifying blood flow. For example, although LSCI reliably detects qualitative changes in flow, LSCI cannot accurately quantify changes in flow or differences in flow between different regions or types of tissue. This is largely because LSCI measurements are highly dependent upon instrumentation, cannot account for the effect of static scatterers that are present in actual tissue, and do not account for noise. Due to these limitations, LSCI is typically limited to measurements of the relative changes in blood flow within a single subject during a single experiment.

### SUMMARY

One implementation of the present disclosure is an illumination system for laser speckle imaging, the illumination system including: a light source configured to output light having a wavelength ranging from 600 nm to 2000 nm; two or more sections of optical fiber; a fiber-coupled acousto-optic modulator (FCAOM), wherein the FCAOM is coupled to the light source by a first section of the two or more sections of optical fiber; and a collimating optic that focuses light output by the wavelength stabilized laser to illuminate a subject within a field of view (FOV), wherein the collimating optic is coupled to the FCAOM by a second section of the two or more sections of optical fiber.

Another implementation of the present disclosure is a laser speckle imaging system including: a light source having an operating wavelength ranging from 600 nm to 2000 nm; an optical fiber; a fiber-coupled acousto-optic modulator (FCAOM), wherein the FCAOM is coupled to the light source by a first section of the optical fiber; a collimating optic that focuses light output by the light source to illuminate a field of view (FOV), wherein the collimating optic is coupled to the FCAOM by a second section of the optical fiber; and an image capture device for capturing images of the FOV when the FOV is illuminated by the light source.

Yet another implementation of the present disclosure is a method of speckle imaging including, within a single exposure time of a laser speckle imaging system: operating a light source and an acousto-optic modulator (AOM) of the laser speckle imaging system to illuminate a field of view (FOV) at a plurality of different modulation frequencies; capturing at least one image of the FOV at each of the plurality of different modulation frequencies; calculating a speckle contrast for each captured image to create one or more sets of speckle contrast images; and extracting a value of inverse correlation time at each pixel using the one or more sets of speckle contrast images.

Yet another implementation of the present disclosure is a method of speckle imaging including: operating a light source and acousto-optic modulator (AOM) of a laser speckle imaging system to produce a first set of pulses having a first time delay therebetween within a first exposure time of the laser speckle imaging system, wherein light output by the light source illuminates a field of view (FOV); operating the light source and the AOM to produce a second set of pulses having a second time delay therebetween within a second exposure time of the laser speckle imaging system, wherein second time delay is different from the first time delay; capturing a series of images of the FOV within each of the first and second exposure times; calculating a speckle contrast for each image of the series of images to create corresponding sets of speckle contrast images; and extracting a value of inverse correlation time at each pixel using the sets of speckle contrast images.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a diagram of an example free space multi-exposure speckle imaging (MESI) system, according to some implementations.

FIG. 1B is a diagram of another example MESI system, according to some implementations.

FIG. 2 is a diagram of an optical fiber-coupled laser speckle imaging system, according to some implementations.

FIG. 3 is a diagram of an example image processing pipeline, according to some implementations.

FIGS. 4A and 4B are graphs illustrating example gating of a MESI pulse sequence, according to some implementations.

FIG. 5 is a graph showing the relative microfluids flow for an example microfluidics flow protocol, according to some implementations.

FIGS. 6A and 6B are graphs illustrating the percent deviation in accuracy and repeatability measurements using the traditional MESI system of FIG. 1A and the FCMESI system of FIG. 2, according to some implementations.

FIG. 7 is an example of in vivo imaging using the traditional MESI system of FIG. 1A and the FCMESI system of FIG. 2, according to some implementations.

FIG. 8A is an example in vivo image captured using the FCMESI system of FIG. 2 in a stroke model, according to some implementations.

FIG. 8B is a graph of average speckle variance based on the in vivo image of FIG. 8A, according to some implementations.

FIG. 9 is a flow diagram of a process for within-exposure modulated speckle imaging using frequency modulating, according to some implementations.

FIG. 10 is a flow diagram of a process for within-exposure modulated speckle imaging using time delay modulation, according to some implementations.

FIG. 11 is an example diagram illustrating the within-exposure modulated speckle imaging process of FIG. 9, according to some implementations.

FIG. 12 is an example diagram illustrating the within-exposure modulated speckle imaging process of FIG. 10, according to some implementations.

FIG. 13A is a diagram of an example temporal relationship between intensity modulation and camera exposure, according to some implementations.

FIG. 13B is a diagram illustrating an example autocorrelation function, according to some implementations.

FIG. 13C is a diagram of a workflow for extracting correlation time for two-pulse modulated multi-exposure images, according to some implementations.

FIG. 14A is an example of raw and speckle contrast images acquired using a two-pulse modulation approach, according to some implementations.

FIG. 14B is a graph comparing measured flow rates with respect to the images in FIG. 14A, according to some implementations.

FIGS. 15A-15C are diagrams illustrating testing results of the two-pulse modulation approach described herein, according to some implementations.

FIGS. 16A and 16B are graphs that compare measured flow rates using two-pulse and sinusoidal modulation, according to some implementations.

### DETAILED DESCRIPTION

To address certain limitations described above with respect to LSCI, multi-exposure speckle imaging (MESI) was developed as an extension of LSCI. MESI requires collecting LSCI images over a wide range of exposure times, and from this sequence of images quantitatively accurate measures of CBF can be extracted. This is possible because MESI allows for separating out the influences of instrumentation, static scattering, and noise from the actual CBF. MESI has been shown to quantify changes in flow with substantially higher accuracy than LSCI, even in the presence of strong static scattering.

As MESI requires a variation in exposure times, the intensity of light incident upon the camera is modulated for several reasons; first, to ensure sufficient signal at short exposure times, second, to prevent saturation at longer exposure times, and, lastly, to create similar average intensities across exposure times to minimize changes in camera and shot noise. Traditionally, this intensity modulation is accomplished with an acousto-optic modulator (AOM), which acts as a variable amplitude gate to the illumination. This additional instrumentation significantly increases the complexity of MESI compared to traditional, single-exposure LSCI. A pilot clinical study of intraoperative MESI during brain tumor resection surgeries found improved quantitative measurements of CBF compared to single-exposure LSCI, but this study was limited to very low temporal resolutions since the constraints of the clinical environment precluded the use of an AOM and required manual adjustments of light intensity.

To further address these, and other, limitations of traditional MESI systems, an optical fiber-coupled MESI (FCMESI) illumination system that uses a fiber-coupled laser and a fiber-coupled AOM (FCAOM) is described herein, according to some implementations. This system is compact and much less complex than other MESI systems, and, unlike other systems, utilizes an FCAOM. The FCMESI system described herein is generally based upon the principles of prior free-space MESI systems but reduces many of the instrumentation challenges of prior systems through the use of fiber-based components. As discussed in greater detail below, the FCMESI system described herein performs comparably to, or better than, traditional MESI systems in both microfluidic and in vivo experiments. Furthermore, the illumination arm of the FCMESI system described herein can be used with many other types of speckle imaging systems and is not limited solely to MESI applications.

In addition to the FCMESI system mentioned above, also described herein is a method of LSCI referred to as “within-exposure modulated speckle imaging” or intensity modulation imaging. A traditional method of illumination is for the laser light to be maintained at a constant intensity throughout the camera exposure time. The exposure time can be varied to increase sensitivity to certain flow ranges. However, with this traditional method, it can be difficult to achieve reproducible blood flow values. Currently, the only way to improve the sensitivity of LSCI to high flows is to reduce the camera exposure time to very short values (e.g., microseconds). These very short exposure times require high illumination powers to detect enough light to capture the speckle pattern. Such high powers are often not possible to achieve due to limitations of laser diodes and/or safety limitations. Notably, modulated intensity imaging is much more sensitive to high flow values without the need to reduce the camera exposure times to prohibitively short values, which enables imaging of high flow with lower average power.

Within-exposure modulated speckle imaging includes varying the intensity of the laser illumination within the exposure time of an imaging device (e.g., a camera). The speckle contrast of the images from modulated illumination can then be related to the underlying flow dynamics in a more quantitative manner. The intensity modulation within a camera exposure can be pulsed, sinusoidal, or any other function. Since the laser illumination is coherent, the speckle contrast of the modulated illumination, integrated over the camera exposure time, will differ depending on the temporal characteristics of the laser illumination. Therefore, the sensitivity of blood flow images can be tuned to different flow levels by changing the nature of the intensity modulation. Additional details are provided below.

### Overview

In LSCI, the decorrelation of the speckle pattern due to dynamic scattering events leads to blurring over the exposure time of the camera, which is quantified by the speckle contrast K, defined as:

$$K = \frac{σ}{〈 I 〉} , \qquad ( 1 )$$

where σ is the standard deviation and [symbol] I [symbol] is the average intensity over a sliding window of pixels. From the square of the speckle contrast, known as the speckle variance, the correlation time, a measure of how rapidly the speckle pattern decorrelates, can be calculated according to the equation:

$${K}^{2} = β \{ \frac{{τ}_{c}}{T} + \frac{{τ}_{c}^{2}}{2 {T}^{2}} [ exp ( - \frac{2 T}{{τ}_{c}} ) - 1 ] \} , \qquad ( 2 )$$

where β is a constant instrumentation factor, T is the exposure time, and τ_{c} is the correlation time. The reciprocal of the correlation time, known as the inverse correlation time (ICT=1/τ−_{c}), is directly related to flow and is often used as a flow metric; the relative ICT (rICT), which is the ICT normalized to some reference value, is often reported when monitoring changes in flow. However, Equation 2 is derived from several simplifying assumptions, such as the absence of static scattering events, that limit the accuracy and repeatability of LSCI.

MESI is based upon a more rigorous model that accounts for static scattering events and non-ideal conditions, producing the MESI equation:

$${K ( T )}^{2} = β [ {ρ}^{2} \frac{exp ( - \frac{2 T}{{t}_{c}} ) - 1 + 2 ( \frac{T}{{t}_{c}} )}{2 {( \frac{T}{{t}_{c}} )}^{2}} + 4 ρ ( 1 - ρ ) \frac{exp ( - \frac{T}{{t}_{c}} ) - 1 + ( \frac{T}{{t}_{c}} )}{{( \frac{T}{{t}_{c}} )}^{2}} + v ] \qquad ( 3 )$$

where ρ is the ratio of collected photons undergoing dynamic scattering events to the total number of collected photons, ν is the noise arising from experimental noise and due to simplifying assumptions made in the model, and all other terms are defined as above. Accounting for these extra factors allows MESI to more accurately quantify changes in flow, especially in the presence of static scatterers. To find the ICT from the MESI equations, speckle contrast images are collected at a series of exposure times, ideally spanning several decades, and the MESI equation is then fitted to the data at each pixel. This fitting procedure allows for β, ρ, ν, and τ_{c}, to be solved for and, ultimately, the ICT values that represent changes in flow to be calculated.

### Multi-Exposure Speckle Imaging (MESI)

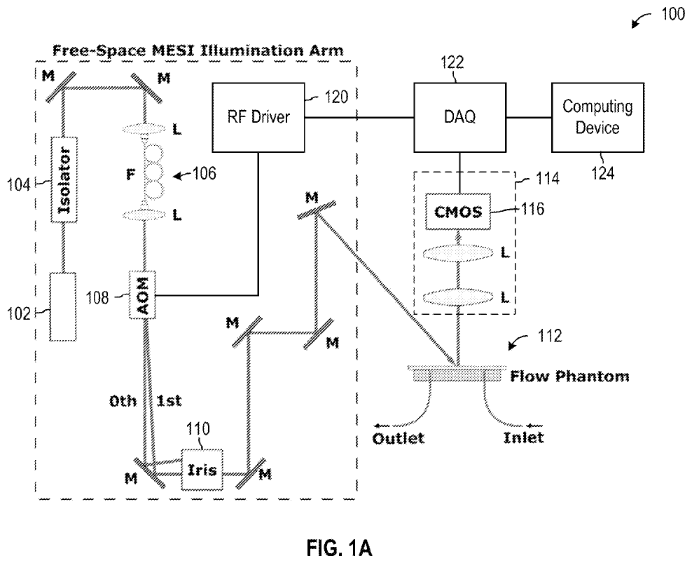

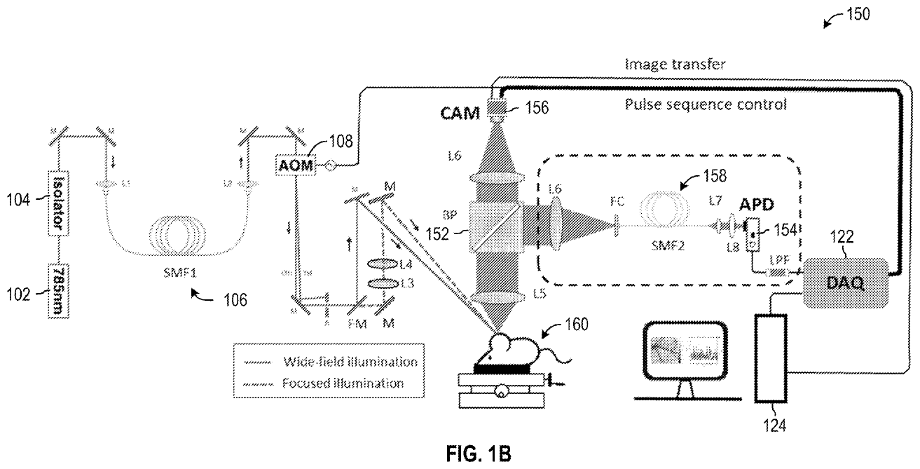

Referring first to FIG. 1A, a diagram of an example free space multi-exposure speckle imaging (MESI) system 100 is shown, according to some implementations. System 100 is, in general, an example of a “traditional” MESI system. As shown, system 100 includes a light source 102 which emits light for imaging. In some implementations, light source 102 is a laser or laser diode, e.g., that emits light in the range of 600 nm to 2000 nm. System 100 further includes an isolator 104, followed by a section of optical fiber 106 and an acousto-optic modulator (AOM) 108. In some implementations, optical fiber 106 is configured for optical correction of abnormal beam shapes provided by light source 102. In particular, optical fiber 106 may be terminated with a collimating lens to produce a circular beam. The collimated output may then pass through AOM 108 and an iris 110 can be used to select the first diffraction order of AOM 108. Generally, AOM 108 is configured to diffract and/or shift the frequency of light using sound waves or, put another way, can be used to control the power/intensity of light emitted by light source 102.

As shown, in some implementations, a series of mirrors and/or lenses may be used to direct the light emitted by light source 102; however, it should be appreciated that the number and/or arrangement of the mirrors and/or lenses may vary based on the specific implementation of system 100. In this example, a plurality of mirrors directs the light to a flow phantom 112 through which a sample of fluid is passed for testing. However, in use, the light may be directed to a blood vessel for measuring blood flow. More generally, the light emitted from light source 102 is directed towards a field of view (FOV) of an image capture system 114. In this case, the FOV of image capture system 114 encompasses at least a portion of flow phantom 112. In some implementations, image capture system 114 includes a camera 116 or other suitable device or sensors for capturing images. In some such implementations, camera 116 is a monochrome camera. In some implementations, image capture system 114 includes one or more lenses for magnifying the FOV.

In some implementations, system 100 includes a radiofrequency (RF) driver 120 for controlling the light throughput of AOM 108. Specifically, in some such implementations, RF driver 120 may output an electrical signal at controlled frequencies which excites a piezo transducer or other similar component of AOM 108 to modulate or adjust the light output by AOM 108. To synchronize image acquisition via image capture system 114 with modulation of AOM 108, a data acquisition device (DAQ) 122 may also be included. DAQ 122 may be generally configured to provide command signals to RF driver 120 to control modulation of AOM 108 and may also receive captured image data from image capture system 114. In some implementations, system 100 further includes a computing device 124 which can interface with DAQ 122 to receive and further process image data and/or to otherwise control RF driver 120 and DAQ 122. In some such implementations, computing device 124 may be a desktop computer, a laptop computer, a server, or any other suitable computing device.

FIG. 1B is a diagram of another example MESI system 150, according to some implementations. Similar to system 100, as described above, system 150 includes light source 102 and isolator 104, followed by a section of optical fiber 106 and AOM 108. In some implementations, MESI system 150 may include one or more mirrors and/or lenses positioned between isolator 104 and optical fiber 106 to direct the light emitted by light source 102. For example, in the illustrated configuration, system 150 includes two mirrors (labelled “M”) followed by a first lens (L1) prior to optical fiber 106. Similarly, a second lens (L2) and respective mirrors are positioned after optical fiber 106. However, it should be appreciated that this particular configuration is not intended to be limiting; rather, the number, arrangement, and/or inclusion of mirrors and/or lenses can vary based on application, layout, etc.

In the illustrated implementation, two illumination light paths are constructed, e.g., after passing through AOM 108, including a wide field path illustrated by a solid line and a focused path illustrated by a dashed line. MESI system 150 is shown to include a flip mirror (labeled “FM”), in some implementations, to switch light between the two paths by a flip mirror; however, it should be appreciated that the light is generally modulated by the same pulse sequence. After contacting a target 160 (e.g., a specimen, flow phantom 112, etc.), the diffusely reflected light is collected, e.g., by an objective lens (L5), and can then be split by a beam splitter 152. A first portion of the light is passed through towards a camera 156 for while a second portion of the light is reflected towards an avalanche photodiode (APD) 154, e.g., to be used for pulse sequence control. In some implementations, beam splitter 152 is a 50/50 beam splitter, e.g., so that the first and second portions of light are roughly equally; however, the present disclosure is not intended to be limiting in this regard.

As shown, camera 156 collects the first portion of reflected light and transfer image data to computing device 124, e.g., for further processing and/or display. The second portion of reflected light is shown to pass through a lens (L6) and fiber coupler (FC) to a second optical fiber 158. In some implementations, second optical fiber 158 is a single-mode fiber (SMF). The light exiting second optical fiber 158 may pass through one or more lenses (L7, L8) before it reaches APD 154. As will be appreciated, APD 154 generates an electrical signal responsive to the received light, which is provided to DAQ 122 to facilitate pulse sequence control. In some implementations, the electric signal output by APD 154 passes through a low-pass filter (LFP) or other suitable filter.

### Optical Fiber-Coupled Laser Speckle Imaging System

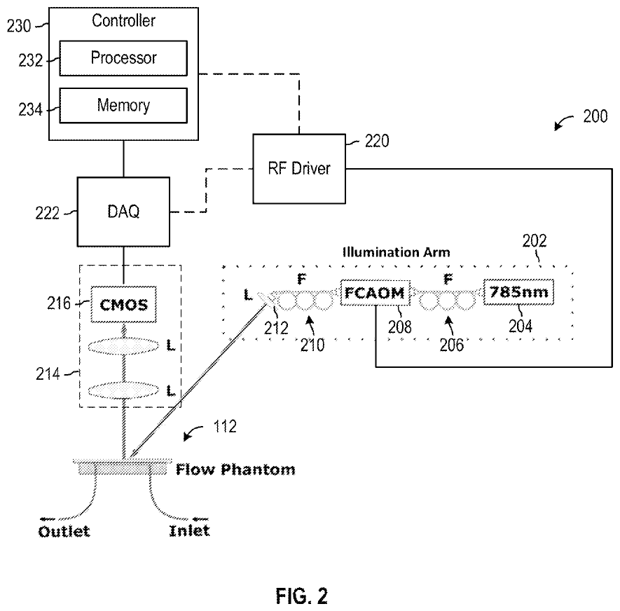

Referring now to FIG. 2, a diagram of an optical fiber-coupled laser speckle imaging system 200 is shown, according to some implementations. Generally, the working principles of system 200 are similar to that of system 100 described above. For example, system 200 includes an illumination arm 202 having a light source 204 that illuminates a FOV (e.g., in this example, containing flow phantom 112) for speckle imaging. However, illumination arm 202 of system 200 is generally constructed of fiber-coupled components which greatly reduces the complexity and size of the system. For example, system 200 generally does not require numerous mirrors for focusing and manipulating the light emitted from a light source, as in system 100. As shown, system 200 also does not include isolator 104 or iris 110. To this point, system 200 may generally be easier to set up, maneuver, and use than system 100, and has fewer points of failure due to the reduced number of components. In some cases, system 200 may even be cheaper to construct than system 100.

Furthermore, the use of fiber-based components and mating sleeves removes the need for careful alignment and realignment of optical components, as well as minimizes the number of pieces that can collect dust, which is especially important in clinical settings and in laboratories outside of the field of optics. Because LSCI applications are growing while MESI adoption is lagging, system 200 can remove a barrier for the adoption of MESI to new applications, both intraoperatively and in new research settings. Given the benefits of MESI, the adoption of FCMESI in settings where LSCI is currently used will allow for accurate monitoring of CBF in a host of applications, ranging from neurosurgery to neuroscience.

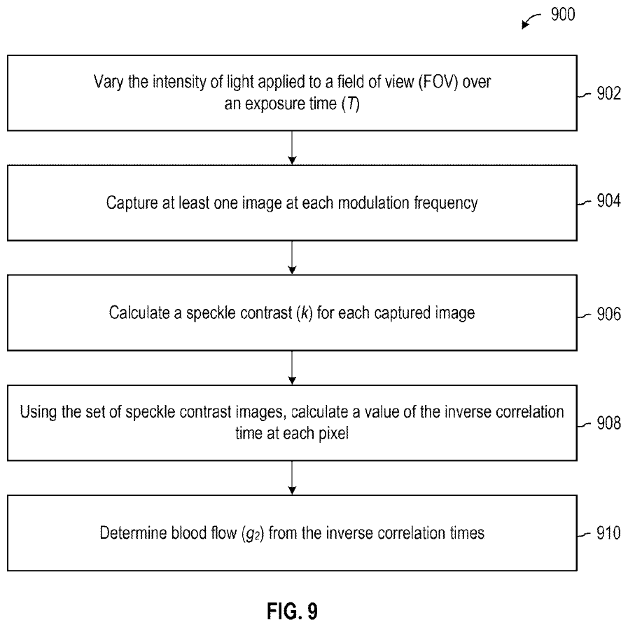

It should also be appreciated that system 200 is not limited only to MESI applications. For example, while system 200 can be used for multi-exposure speckle imaging, illumination arm 202 and the components thereof make system 200 suitable for other forms of laser speckle imaging. In some implementations, system 200 can be used to implement a within-exposure modulation method of speckle imaging, as described in greater detail below with respect to FIGS. 9-12. Within-exposure modulation is a technique for speckle imaging that involves modulating the intensity of light applied to a subject within the FOV. Within-exposure modulation may also be referred to as intensity-modulation speckle imaging. Thus, this disclosure contemplates system 200 being suitable for a variety of speckle imaging techniques, including MESI and within-exposure modulation.

As shown, illumination arm 202 of system 200 further includes a fiber-coupled AOM (FCAOM) 208 coupled to light source 204 via a first section of optical fiber 206. In some implementations, light source 204 is a volume-holographic grating (VHG) stabilized laser diode that outputs light having a primary wavelength of 785 nm. It should be understood that a VHG-stabilized laser is provided only as an example. This disclosure contemplates using other laser sources, e.g., including non-wavelength stabilized lasers. Additionally, it should be understood that 785 nm is provided only as an example for the primary wavelength. This disclosure contemplates using a light source having a primary wavelength more or less than 785 nm. For example, light source 204 may operate at a wavelength in the range of 600 nm to 2000 nm.

In some implementations, FCAOM 208 has a rise time of 50 ns; although, FCAOM 208 can be configured for other rise times which are contemplated herein. In some implementations, optical fiber 206—or at least a portion of optical fiber 206—is part of, or fixedly coupled to, light source 204. Likewise, in some implementations, a portion of optical fiber 206 or the entirety of optical fiber 206 may be part of, or fixedly coupled to, FCAOM 208. For example, a first portion of optical fiber 206 may extend from an output side of light source 204 and a second portion of optical fiber 206 may extend from an input side of FCAOM 208. In some such implementations, the portions of optical fiber 206 can be coupled by a mating sleeve. It should be appreciated that the specific configuration of system 200 is not limited to just this description, however. For example, in other implementations, optical fiber 206 may be a separate component from light source 204 and/or FCAOM 208, and thus may be removably coupled to both components.

In some implementations, illumination arm 202 further includes a second section of optical fiber 210 that couples FCAOM 208 to a collimating optic 212. Optionally, the collimating optic 212 is an adjustable focal length collimating optic. In some such implementations, adjustable focal length collimating optic 212 can be used to adjust the illumination of the FOV (e.g., generally encompassing a portion of flow phantom 112 in the example shown). As with optical fiber 206, in some cases, optical fiber 210 or a portion thereof may be part of (e.g., fixedly coupled to) FCAOM 208. For example, optical fiber 210 may extend from an output of FCAOM 208. In other implementations, optical fiber 210 is a distinct component from FCAOM 208 and therefore may be removably coupled to FCAOM 208 and/or adjustable focal length collimating optic 212. Generally, one or both of optical fibers 206, 210 are single mode optical fibers. It should be understood that an adjustable focal length collimating optic is provided only as an example. This disclosure contemplates using other collimating optics.

Like system 100, system 200 is shown to include an image capture system 214 which includes one or more lenses and an image capture device 216. In some implementations, image capture device 216 is any suitable camera or image sensor, such as a monochrome camera (e.g., a 155 μm camera). In the example shown, image capture system 214 includes two lenses. In some implementations, at least one of the lenses is configured to magnify the FOV with respect to image capture device 216. In some implementations, image capture system 214 includes a long pass filter to filter out visible light. For example, the long pass filter may be one of the lenses shown in FIG. 2. Coupled to image capture device 216 is a DAQ 222 which can receive, and optionally process, image data captured by image capture device 216. In some implementations, DAQ 222 is further configured to trigger image capture device 216 (e.g., to cause image capture device 216 to capture an image or images). Optionally, DAQ 222 may be communicably coupled to an RF driver 220 which modulates the light throughput of FCAOM 208 by applying electrical signals to FCAOM 208. Specifically, DAQ 222 may communicate with RF driver 220 to synchronize light output or modulation with the triggering of image capture device 216.

In some implementations, system 200 includes a controller 230 which is also in communication with one or both of RF driver 220 and DAQ 222. Generally, controller 230 is configured to receive, process, and/or store image data from DAQ 222. In some implementations, controller 230 performs all of the functions of DAQ 222; thus, DAQ 222 may not be included. In some implementations, controller 230 provides control signals to RF driver 220 (e.g., as opposed to DAQ 222 providing the control signals), thereby coordinating operations of the components of illumination arm 202 and image capture system 214. It will be appreciated that any such arrangement and implementation of the components of system 200 is contemplated herein.

As shown, controller 230 generally includes a processor 232 and memory 234. Accordingly, controller 230 may be any suitable computing device (e.g., a laptop computer, a server, etc.). Processor 232 can be a general-purpose processor, an application specific integrated circuit (ASIC), one or more field programmable gate arrays (FPGAs), a group of processing components, or other suitable electronic processing structures. In some embodiments, processor 232 is configured to execute program code stored on memory 234 to cause controller 230 to perform one or more operations, as described below in greater detail. In some implementations, controller 230 may be part of another computing device (e.g., DAQ 222 or another computer); thus, the components of controller 230 may be shared with, or the same as, the host device.

Memory 234 can include one or more devices (e.g., memory units, memory devices, storage devices, etc.) for storing data and/or computer code for completing and/or facilitating the various processes described in the present disclosure. In some embodiments, memory 234 includes tangible (e.g., non-transitory), computer-readable media that stores code or instructions executable by processor 232. Tangible, computer-readable media refers to any physical media that is capable of providing data that causes controller 230 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 234 can include RAM, ROM, hard drive storage, temporary storage, non-volatile memory, flash memory, optical memory, or any other suitable memory for storing software objects and/or computer instructions. Memory 234 can include database components, object code components, script components, or any other type of information structure for supporting the various activities and information structures described in the present disclosure. Memory 234 can be communicably connected to processor 232 and can include computer code for executing (e.g., by processor 232) one or more processes described herein.

While shown as individual components, it will be appreciated that processor 232 and/or memory 234 can be implemented using a variety of different types and quantities of processors and memory. For example, processor 232 may represent a single processing device or multiple processing devices. Similarly, memory 234 may represent a single memory device or multiple memory devices. Additionally, in some embodiments, controller 230 may be implemented within a single computing device (e.g., one server, one housing, etc.). In other embodiments, controller 230 may be distributed across multiple devices (e.g., that can exist in distributed locations). For example, controller 230 can include multiple distributed computing devices (e.g., multiple processors and/or memory devices) in communication with each other that collaborate to perform operations.

### Experimental Setup and Results

The ability of both AOM 108 and FCAOM 208 to gate the laser illumination was tested using an appropriate photodiode. A pulse sequence, covering the first ten exposure times in a MESI pulse sequence, was supplied to each of AOM 108 and FCAOM 208 (e.g., via respective light sources 102, 204), and the optical power was measured. Microfluidic flow phantoms (e.g., flow phantom 112) were used to test the ability of the systems to quantify changes in flow. For these tests, flow phantom 112 was constructed of polydimethylsiloxane (PDMS) with the addition of titanium dioxide to mimic the scattering properties of tissue. A 300×300 μm square channel was embedded within the phantom with a glass coverslip bonded on top, and plastic tubing was connected to produce an inlet and outlet to the channel.

A solution of 1.1 μm diameter polystyrene microspheres in deionized water was used to produce a solution to mimic the optical properties of blood at 785 nm (e.g., the wavelength of light source 204). Specifically, Mie theory was used to calculate the scattering coefficient of the microspheres and the concentration was then adjusted to match the reduced scattering coefficient of blood (1.3 mm⁻¹). By volume, the solution consisted of 4.8% microsphere solution, 0.1% Tween® 20 (P1379-100ML, Sigma-Aldrich) to prevent the clumping of the microspheres, and the remainder was deionized water.

Flow within the system was regulated with an external flow control system (not shown in the figures). In summary, the polystyrene solution was stored in a reservoir connected to a pressure regulator, and the outlet of the reservoir was connected to plastic tubing that connected the reservoir to the microfluidic channel inlet. The outlet of the microfluidic channel was placed in a separate collection reservoir. Flow was monitored at two different points using two separate flow sensors, one before the channel and one after. Both flow sensors were connected to a control hub that interfaced with the control computer (e.g., controller 230).

Flow speed was set as a step function, ranging from 1-10 mm/s at an interval of 1 mm/s. Each step was held for 90 seconds, and the entire protocol was followed by a 30 second period where flows was set to 0 mm/s. The total experiment time was 15.5 minutes. This protocol was run both while imaging with the free space MESI system, system 100, and the FCMESI system, system 200. MESI images were acquired continuously throughout the protocol for a total of 1950 image sequences, with each sequence consisting of 15 images collected at the 15 different exposure times. For system 200, the protocol was run three separate times, with the start of each trial separated by approximately 20 minutes. As free space MESI systems, such as system 100, have been thoroughly tested in the past and by others in the art, the microfluidic protocol was only run once with it.

For testing, mice were anesthetized with isoflurane and body temperature was maintained with a heating pad during all procedures. Craniotomies were performed in two mice to remove a portion of the skull and replace it with a glass coverslip held in place by dental cement. A photothrombotic stroke was induced in one of the mice by injecting Rose Bengal dye and then illuminating a region of the cortical surface with 532 nm light, inducing a stroke. A photothrombotic stroke was induced in one of the mice by retro-orbitally injecting Rose Bengal dye (15 mg/kg) and then focusing 532 nm light on a penetrating arteriole in the motor cortex. MESI was performed three weeks after stroke induction, and each mouse was imaged through the cranial window using both the free space and FCMESI systems—system 100 and 200, respectively. For each imaging session, 56 sequences of 15 frames of 15 different exposure times were acquired.

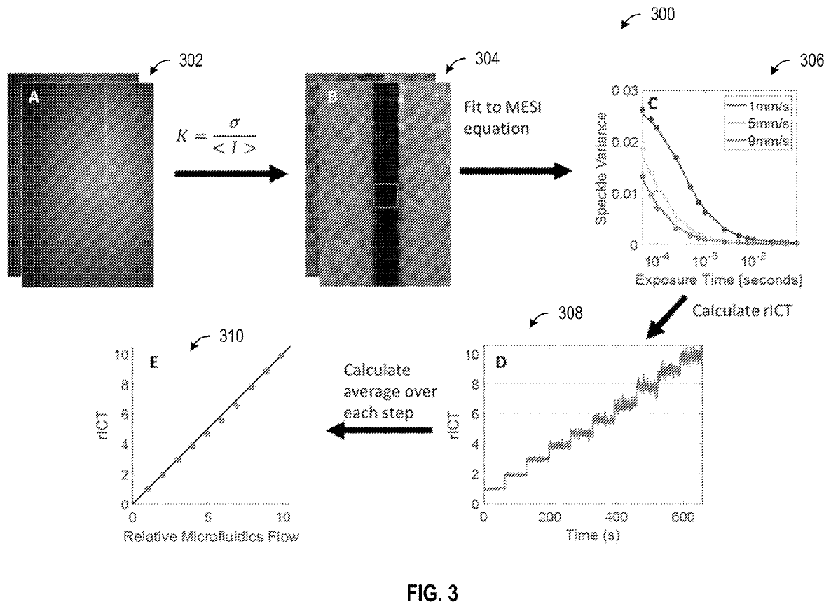

Processing on the collected images was then performed based on the example image processing pipeline 300 shown in FIG. 3. For every raw image collected, shown as raw images 302, a speckle contrast was calculated over a 7×7 pixel sliding window to produce speckle contrast images 304. For the microfluidics experiments, a 40×40 pixel region of interest (ROI) was chosen to correspond to the width of the microfluidic channel in FCMESI (e.g., system 200) images. Within this ROI in the speckle contrast images, the arithmetic mean was calculated to produce a single speckle contrast value at each exposure time, shown in graph 306. Using this average value, the ICT was found by fitting the measured K²(T) to Equation 3, described above. Given issues in the numerical stability of fitting results in Equation 3, β was chosen to be a constant value during the fitting process to remove one of four variables from the fitting process. The value of β was chosen by finding the median value of K for each exposure time for frames in the 1 mm/s step in the microfluidics step function, fitting this data to Equation 3, and selecting the resulting β value as its true constant value.

To remove the impact of the transition time between flow speeds in the flow protocol, 25 frames of data on each side of the midpoint of the transition between speeds were removed. This cropping of the data and the subsequent fitting of ICT produced a sequence of ICT values corresponding to the ten steps in the step function. All ICT values were normalized to the mean ICT value for the slowest flow speed to produce a timecourse of rICT values, shown in graph 308. The relative microfluidics flow (rM) was found by taking the mean flow value of the two flow sensors and then taking the mean at each flow speed, normalizing to the first step. The rICT was then plotted against relative microfluidics flow for each flow speed, as shown in graph 310.

For each step in the step function, the arithmetic mean of the ICT was found for each trial. Furthermore, using the rICT and the mean of the relative microfluidics (rM) values at each step allowed us to calculate the mean percent deviation in accuracy (Δ_{ACC}) and in repeatability (Δ_{REP}) at each step according to the following equations:

$${Δ}_{ACC} = 100 \vert \frac{rICT - \overline{rM}}{\overline{r M}} \vert , \qquad ( 4 )$$

$${Δ}_{REP} = 100 \vert \frac{rICT - \overline{rICT}}{\overline{rICT}} \vert . \qquad ( 5 )$$

These metrics allow for quantifying the ability to accurately determine changes in flow (Δ_{ACC}) and the stability of those measurements (Δ_{REP}). Because three separate trials were performed on system 200, the mean and standard deviation of Δ_{ACC} and Δ_{REP} were found for FCMESI.

For in vivo imaging, the speckle contrast was calculated for each of the images. All images captured at the same exposure were averaged together to produce one dataset consisting of 15 average images for each of the 15 different exposure times. The ICT was then found over the entire relevant FOV by fitting the data at each pixel to the MESI equation. For the imaging of the stroke model using the FCMESI system, three ROIs were chosen, corresponding to a vessel, the parenchyma, and the infract, and the goodness of fit to the MESI equation was determined.

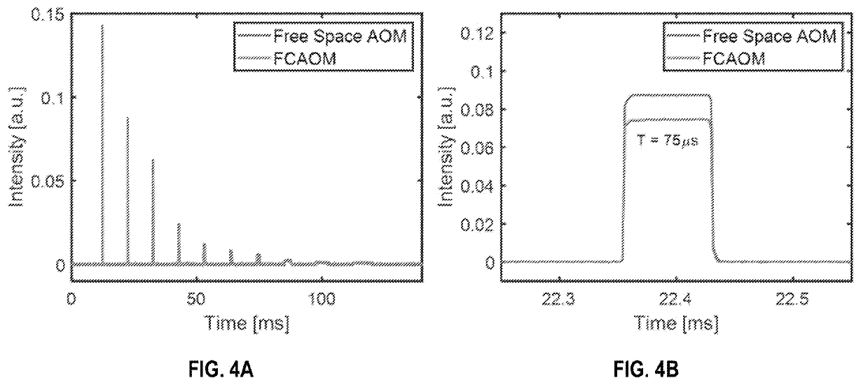

Referring now to FIGS. 4A and 4B, graphs illustrating example gating of a MESI pulse sequence are shown, according to some implementations. As illustrated, both the free-space AOM (e.g., AOM 108) and FCAOM 208 showed a similar ability to gate the optical signal for a MESI sequence of different exposure times. FIG. 4A shows, for example, signal intensity for both AOM 108 and FCAOM 208 over ten exposure times. For the ten different exposure times, each AOM modulated the optical throughput to decrease instantaneous optical power as the exposure times increased. As AOM 108 and FCAOM 208 had unique calibration curves, the absolute value of the optical power is different between each pulse sequence, but each produces a pulse sequence of comparable shape. Furthermore, each individual pulse within the sequence had similar shape, form, and rise time, despite different absolute measured values. FIG. 4B illustrates these characteristics through a close up view of the second pulse shown in FIG. 4A. These results indicate that there is no substantial difference in ability between the two systems to generate MESI pulse sequences.

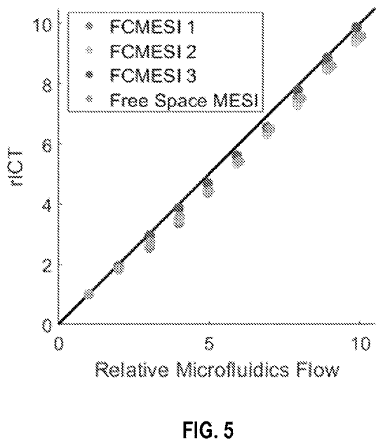

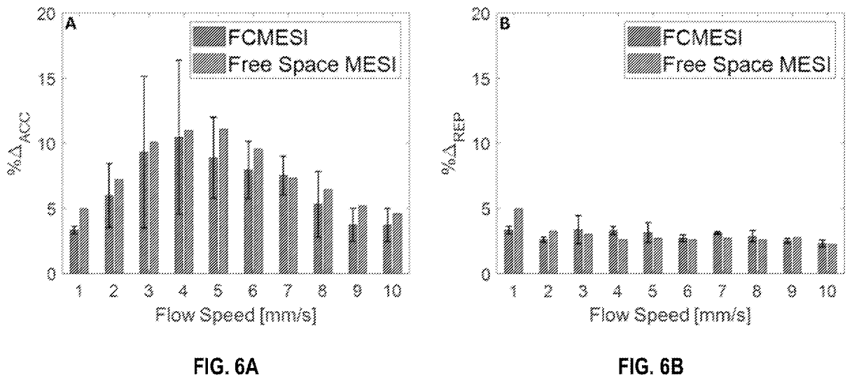

FIG. 5 shows an example graph of rICT plotted against rM for each of the 10 speeds in the step function for the four tests runs of the microfluidics flow protocol (e.g., three for system 200 and one with system 100, as described above). Although rICT and rM are not equal across all steps, they are similar throughout the entire step function. Significantly, the rICT from system 100 was nearly always within the range of values from the trials of system 200, indicating that the performance of system 200 when measuring changes in flow in a microfluidic channel is comparable to that of more traditional free-space MESI (e.g., system 100). The mean Δ_{ACC} for system 200 was less than that for system 100 at all speeds, although the standard deviation in Δ_{ACC} is large enough at lower speeds (e.g., less than and equal to 4 mm/s) that the performance of system 100 falls within the expected performance of system 200, as shown in FIG. 6A.

FIGS. 6A and 6B, in particular, show the percent deviation in accuracy and repeatability measurements, with error bars denoting the range of the standard deviation from the mean. System 200 performance is denoted by the blue bars while system 100 performance is shown in orange. In FIG. 6A, the percent deviation in accuracy (Δ_{ACC}) versus flow speed is shown. The mean error in accuracy for system 200 is lower than that of older systems (e.g., system 100) at all flow speeds, although there are large error bars for the 2-4 mm/s steps. FIG. 6B shows percent deviation in repeatability (Δ_{REP}) plotted against flow speed. While there was no consistent trend in repeatability across all flow speeds, the upper bound in error at every speed is less than 6% and there is no substantial difference between the two systems. Altogether, this data demonstrates that system 200 had comparable accuracy and repeatability as compared to system 100, despite the changes in hardware.

As the flow speed in the aforementioned microfluidics system has been demonstrated to be remarkably stable, issues in accuracy and repeatability in rICT are generally caused by errors in MESI imaging and fitting to the MESI equation. In terms of accuracy, MESI appears to systematically underestimate flow in almost all cases, especially for the speeds of 3-5 mm/s. This issue is likely caused by the stability of the numeric calculations, especially the fact that β was viewed as a constant, potentially introducing a systematic bias. This could be addressed with a different way of fitting β, a different fitting algorithm, or even utilizing a different model or using several models depending upon flow condition. Despite these potential numerical shortcomings, FCMESI (e.g., system 200) is able to quantify changes in flow with accuracy and repeatability on the level of previous MESI systems (e.g., system 100), and has been shown to have significant benefits in quantifying changes in flow compared to single-exposure LSCI.

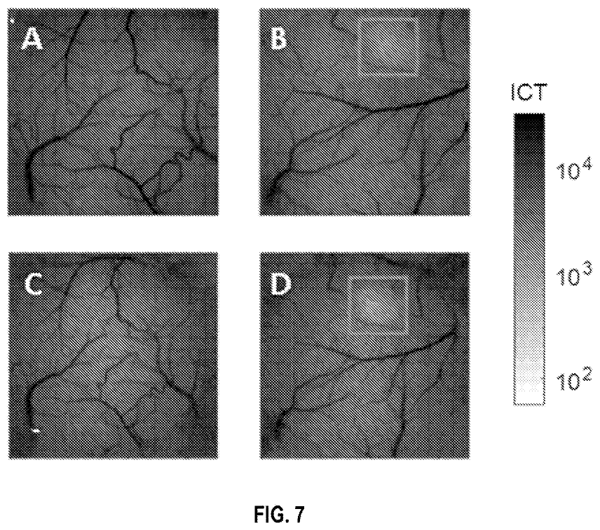

Referring now to FIG. 7, example in vivo images from the aforementioned mouse experiment are shown, according to some implementations. FIG. 7 specifically shows, in the upper lefthand corner, an image of a control mouse collected on system 100; in the upper righthand corner, and image of a stroke model collected on system 100 with the infract enclosed in a box; in the lower lefthand corner, an image of a control mouse on collected system 200; and in the lower righthand corner, an image of a stroke model collected on system 200 with the infarct enclosed in a box. In mouse imaging, both systems 100 and 200 were able to detect the infarct in the case of the stroke mouse and map the vasculature of the healthy mouse. Due to different magnifications on both systems, the vascular networks are not exactly comparable, and the resolution is higher on system 100 due to higher magnification. However, all major features on the cortical surface are clearly visible in both sets of images, showing that FCMESI (e.g., system 200) can image neurovascular networks.

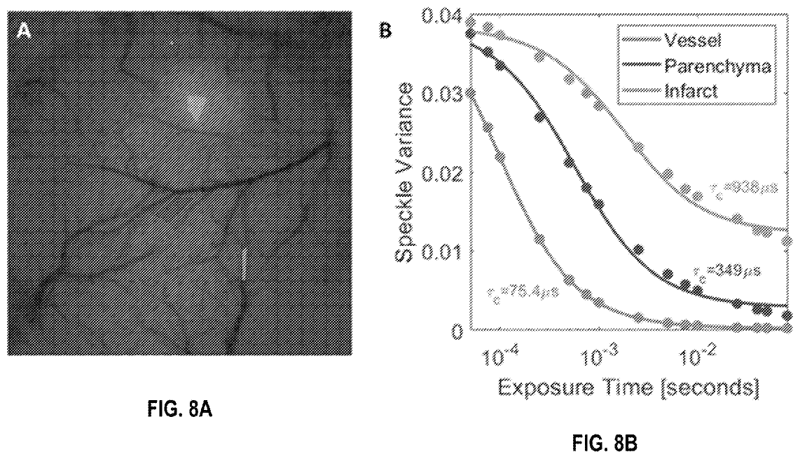

To further demonstrate the ability of FCMESI in widefield mouse imaging, the different ROIs were chosen within the FCMESI image of the stroke model. Each of these three ROIs corresponded to a different significant feature: a vessel, the parenchyma, and the infarct, which are highlighted in FIG. 8A. Speckle contrast was averaged across each ROI and fit to Equation 3, and the fits were plotted against the measured data as shown in FIG. 8B. The trend in calculated τ_{c} followed expectations as it was highest in the infarct (τ_{c}=938 μs), slightly lower in the parenchyma (τ_{c}=349 μs), and much lower in the vessel (τ_{c}=75.4 μs), a result consistent with the inverse proportionality between τ_{c} and CBF. The goodness of fit, determined by the mean squared error (MSE), was best in the vessel (MSE=0.0054) and worst in the infarct (MSE=0.0171) with the parenchyma fit quality being in between (MSE=0.0109), suggesting a correlation between increased flow and increased goodness of fit to the MESI equation. Taken together, these fits demonstrate that FCMESI can discriminate between the different flow rates in different tissue structures in a mouse brain; providing further evidence that system 200 can be used in a clinical setting with complex anatomy.

### Within-Exposure Modulated Speckle Imaging

As noted above, within-exposure modulated speckle imaging generally includes varying the intensity of laser illumination within the exposure time of an imaging device (e.g., a camera). In some implementations, the varying of intensity of the laser (e.g., a light source) is achieved by modulating the light throughput of an AOM (e.g., AOM 108, FCAOM 208). The AOM modulation function can be defined as m(t), the intact speckle signal as I(t), and the modulated speckle signal as Iₘ(t) such that:

$${I}_{m} ( t ) = I ( t ) m ( t )$$

Then the intensity of pixel i on the image capture device (e.g., a camera sensor) within intensity-modulated exposure time T would be

$${S}_{i , T} = \frac{1}{T} {\int }_{0}^{T} {I}_{i} ( {t}^{′} ) m ( {t}^{′} ) {dt}^{′}$$

where Iᵢ(t) is the intact speckle signal of pixel i and m(t) is the modulation function on the illumination intensity.

The intensity modulation can then be defined as:

$$M ( τ ) = {\int }_{0}^{T - τ} m ( t ) m ( t + τ ) d τ$$

and expression of speckle contrast of the within-exposure intensity modulated speckle signal as:

$${K}^{2} = \frac{2 {〈 I 〉}^{2}}{{T}^{2} {〈 {I}_{m} 〉}^{2}} {\int }_{0}^{T} {g}_{2} ( τ ) M ( τ ) d τ - 1$$

where K is the speckle contrast, g₂ is blood flow, and M(τ) is the intensity modulation. Notice that when the modulation function m(t) is a constant 1, M=T−τ and this equation reduces to the expression of speckle contrast that is commonly seen (e.g., as described above). In other words, the classic expression of speckle contrast is a particular case when illumination intensity is held constant.

With respect to square wave modulation, speckle contrast expression can be defined as:

$${K}^{2} = \frac{2}{{T}_{e}^{2}} {\int }_{0}^{{T}_{min}} ( {T}_{e} - \frac{{T}_{e}}{{T}_{min}} τ ) ( {g}_{2} ( τ ) - C ) d τ + C - 1$$

the assumption that g₂(τ)−C decreases to 0 before M₂(τ) starts, i.e. τ_{c}<<Tₘᵢₙ/d, where C is the constant part of g₂(τ), i.e. lim_{τ→∞}g₂(τ)=C.

Plugging an assumed g₂(τ) into this equation can establish a relationship between speckle contrast and correlation time in different g₂(τ) models as follows:

$${K}^{2} ( {T}_{e} , {T}_{min} ) = β {ρ}^{2} \frac{{e}^{- 2 {x}_{2}} - 1 + \sqrt{2 π {x}_{2}} erf ( \sqrt{2 {x}_{2}} )}{2 {x}_{1} {x}_{2}} + 2 β ρ ( 1 - ρ ) \frac{{e}^{- {x}_{2}^{2}} - 1 + \sqrt{π {x}_{2}} erf ( \sqrt{{x}_{2}} )}{{x}_{1} {x}_{2}} + {β ( 1 - ρ )}^{2} + {v}_{n}$$

$${K}^{2} ( {T}_{e} , {T}_{min} ) = β {ρ}^{2} \frac{{e}^{- 2 {x}_{2}} - 1 + 2 {x}_{2}}{2 {x}_{1} {x}_{2}} + 4 β ρ ( 1 - ρ ) \frac{{e}^{- {x}_{2}} - 1 + {x}_{2}}{{x}_{1} {x}_{2}} + β {( 1 - ρ )}^{2} + {v}_{n}$$

$${K}^{2} ( {T}_{e} , {T}_{min} ) = β {ρ}^{2} \frac{{e}^{- 2 \sqrt{{x}_{2}}} ( 4 {x}_{2} + 6 \sqrt{{x}_{2}} + 3 ) + 2 {x}_{2} - 3}{2 {x}_{1} {x}_{2}} + 8 βρ ( 1 - ρ ) \frac{{e}^{- \sqrt{{x}_{2}}} ( 2 {x}_{2} + 6 \sqrt{{x}_{2}} + 6 ) + {x}_{2} - 6}{{x}_{1} {x}_{2}} + {β ( 1 - ρ )}^{2} + {v}_{n}$$

where

$${x}_{1} = \frac{{T}_{e}}{{τ}_{c}} and {x}_{2} = \frac{{T}_{min}}{{τ}_{c}} .$$

### Here,

$$erf ( x ) = \frac{2}{\sqrt{π}} {\int }_{0}^{x} {e}^{- {t}^{2}} dt .$$

The equations above correspond to Gaussian, Lorentzian and Sqrt g₂(τ) models, respectively.

Referring now to FIG. 9, a flow diagram of a process 900 for within-exposure modulated speckle imaging using frequency modulation is shown, according to some implementations. In some implementations, process 900 is implemented using/by system 200, as described above. For example, process 900 may be implemented, at least in part, by controller 230. Additionally, or alternatively, process 900 may be at least partially implemented by RF driver 220 and/or DAQ 222. It should be appreciated, however, that process 900 may also be implemented by system 100 or system 150 (e.g., by computing device 124) or other suitable laser speckle imaging systems. In some cases, certain steps of process 900 may be optional and process 900 may be implemented using less than all of the steps. It will also be appreciated that the order of steps shown in FIG. 9 is not intended to be limiting.

It should also be noted that one or more steps of process 900, as described below, may be implemented within a single exposure—defined by time T—of an image capture device (e.g., camera 156, image capture device 216); hence the term “within-exposure modulated” speckle imaging. In some implementations, at least steps 902 and 904 are performed with the exposure time (T); however, steps 906 and/or 908 could also be performed within the exposure time. Throughout the following description of FIG. 9, reference may be made to the various equations described above.

At step 902, the intensity of light applied to a field of view (FOV) of a MESI system is varied over exposure time (T). In some implementations, the intensity of light is varied sinusoidally; however, other waveforms are contemplated herein. In this regard, the FOV is illuminated at a plurality of different modulation frequencies. In some implementations, the intensity of light is modulated by controlling a light source, such as isolator 104 or light source 204. For example, controller 230 may control light source 204 by sending control signals and/or modulating power to light source 204. In some implementations, the intensity of light is modulated by controlling an AOM, such as AOM 108 or FCAOM 208. In some such implementations, controller 230 may cause RF driver 220 to modulate the light throughput of FCAOM 208 to illuminate the FOV at various modulation frequencies. Alternatively, RF driver 220 may control FCAOM 208 based on data provided by DAQ 222. Likewise, in some implementations, DAQ 122 and/or computing device 124 may control AOM 108 to modulate the light throughput of AOM 108.

It should, however, be appreciated that controlling a light source and/or AOM of a laser speckle imaging system (e.g., system 150) is not the only way to modulate/vary the intensity of light over time. As such, the present disclosure contemplates various other methods to achieve modulation of light intensity. For example, the intensity of light can be modulated, e.g., in any of system 100, system 150, or system 200, using (e.g., by controlling) one or more of an electro-optic modulator (EOM), direct modulation of laser diode current (e.g., electrical modulation), or mechanical modulation (e.g., a chopper wheel). These and other techniques for the modulation of light intensity, e.g., as in step 902, are contemplated herein.

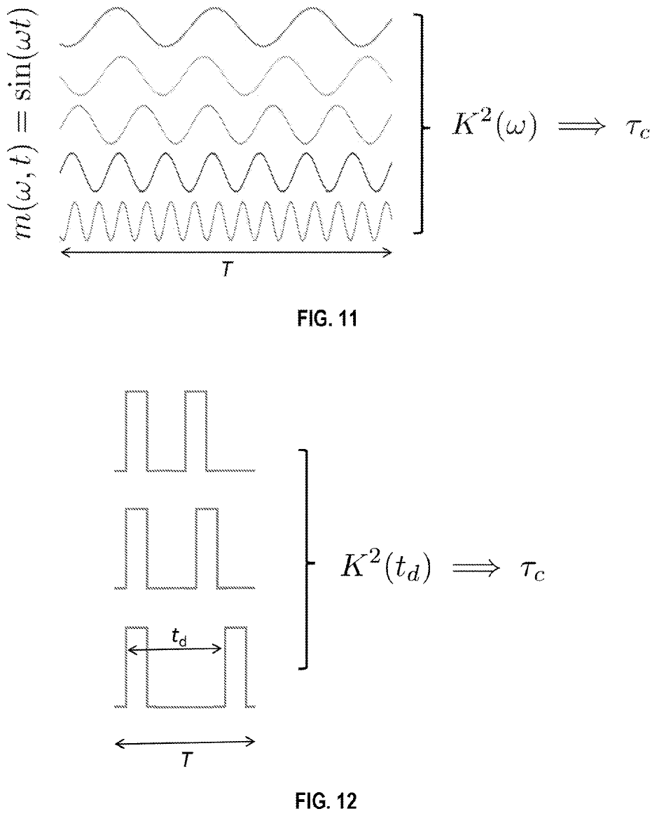

An example of the modulation of light illuminating the FOV is shown in FIG. 11, where five different modulation frequencies (co) are illustrated within an exposure time, T, of an image capture device (e.g., camera 156, image capture device 216). In some implementations, the light that illuminates the FOV may be modulated at each modulation frequency within a single exposure time, T For example, the light throughput of FCAOM 208 can be emitted (e.g., onto the FOV) at each modulation frequency within a single exposure time, such that the modulation frequency of the light changes throughout the exposure.

At step 904, a least one image of the FOV is captured at each modulation frequency. In some implementations, DAQ 222 and/or controller 230 may store images throughout the exposure time, T, of image capture device 216 to generate a sequence of images at the different modulation frequencies. Likewise, computing device 124 may store images through exposure time, T, of camera 156. Subsequently, at step 906, a speckle contrast (K) is calculated for each captured image. Generally, speckle contrast will vary as a function of modulation frequency. In FIG. 11, for example, five different modulation frequencies are used to create sets of speckle contrast images, K(ω₁), K(ω₂), K(ω₃), K(ω₄), and K(ω₅).

At step 908, a value of the inverse correlation time (τ_{c}) at each pixel is calculated using the speckle contrast images. In some implementations, each set of speckle contrast images (e.g., K(ω₁), K(ω₂), K(ω₃), K(ω₄), and K(ω₅)) are used to extract the value of the inverse correlation time (τ_{c}) at each pixel. The expression for calculating inverse correlation time (τ_{c}) is described above. Optionally, at step 910, blood flow (g₂) is can be determined based on the value of the inverse correlation time at each pixel, again using the equations described above.

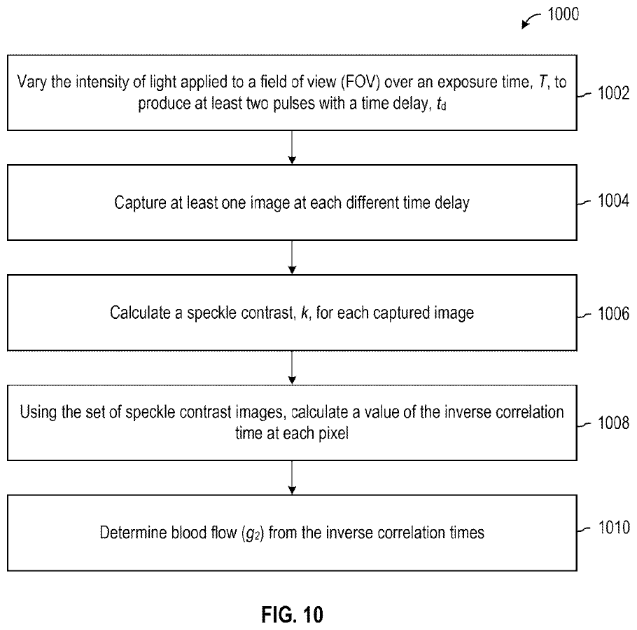

Referring now to FIG. 10, a flow diagram of a process 1000 for within-exposure modulated speckle imaging using time delay modulation is shown, according to some implementations. In some implementations, process 1000 is implemented using/by system 200, as described above. For example, process 1000 may be implemented, at least in part, by controller 230. Additionally, or alternatively, process 1000 may be at least partially implemented by RF driver 220 and/or DAQ 222. It should be appreciated, however, that process 1000 may also be implemented by system 100 or system 150 (e.g., by computing device 124) or other suitable laser speckle imaging systems. In some cases, certain steps of process 1000 may be optional and process 1000 may be implemented using less than all of the steps. It will also be appreciated that the order of steps shown in FIG. 10 is not intended to be limiting. Throughout the following description of FIG. 10, reference may be made to the various equations described above.

At step 1002, the intensity of light applied to a field of view (FOV) of a MESI system is varied over exposure time (T) to produce at least two pulses separated by a time delay (t_{d}). In some implementations, the intensity of light is modulated by controlling a light source, such as isolator 104 or light source 204. For example, controller 230 may control light source 204 by sending control signals and/or modulating power to light source 204. In some implementations, the intensity of light is modulated by controlling an AOM, such as AOM 108 or FCAOM 208. In some such implementations, controller 230 may cause RF driver 220 to modulate the light throughput of FCAOM 208 to illuminate the FOV at various modulation frequencies. Alternatively, RF driver 220 may control FCAOM 208 based on data provided by DAQ 222. Likewise, in some implementations, DAQ 122 and/or computing device 124 may control AOM 108 to modulate the light throughput of AOM 108.

It should, however, be appreciated that controlling a light source and/or AOM of a laser speckle imaging system (e.g., system 150) is not the only way to modulate/vary the intensity of light over time. As such, the present disclosure contemplates various other methods to achieve modulation of light intensity. For example, the intensity of light can be modulated, e.g., in any of system 100, system 150, or system 200, using (e.g., by controlling) one or more of an EOM, direct modulation of laser diode current (e.g., electrical modulation), or mechanical modulation (e.g., a chopper wheel). These and other techniques for the modulation of light intensity, e.g., as in step 1002, are contemplated herein.

An example of the modulation of light illuminating the FOV is shown in FIG. 12. In this example, three different sets of pulses are shown, each having a distinct time delay (t_{d}) between the pulses. In some implementations, each set of pulses is emitted in a separate exposure. For example, in FIG. 12, three different exposure times may be needed to capture each set of pulses. However, each set of pulses is generally executed within a single exposure time.

At step 1004, a least one image of the FOV is captured for each set of pulses or, put another way, for each time delay. For example, in some implementations, DAQ 222 and/or controller 230 capture sets of images to produce a sequence of images at each different delay time. Subsequently, at step 1006, a speckle contrast (K) is calculated for each captured image. Generally, speckle contrast will vary as a function of delay time (t_{d}). In FIG. 12, for example, three different delay times are used to create sets of speckle contrast images, K(t_{d1}), K(t_{d2}), and K(t_{d3}).

At step 1008, a value of the inverse correlation time (τ_{c}) at each pixel is calculated using the speckle contrast images. In some implementations, each set of speckle contrast images (e.g., K(t_{d1}), K(t_{d2}), and K(t_{d3})) are used to extract the value of the inverse correlation time (τ_{c}) at each pixel. The expression for calculating inverse correlation time (τ_{c}) is described above. Optionally, at step 1010, blood flow (g₂) is can be determined based on the value of the inverse correlation time at each pixel, again using the equations described above.

### Additional Experimental Results

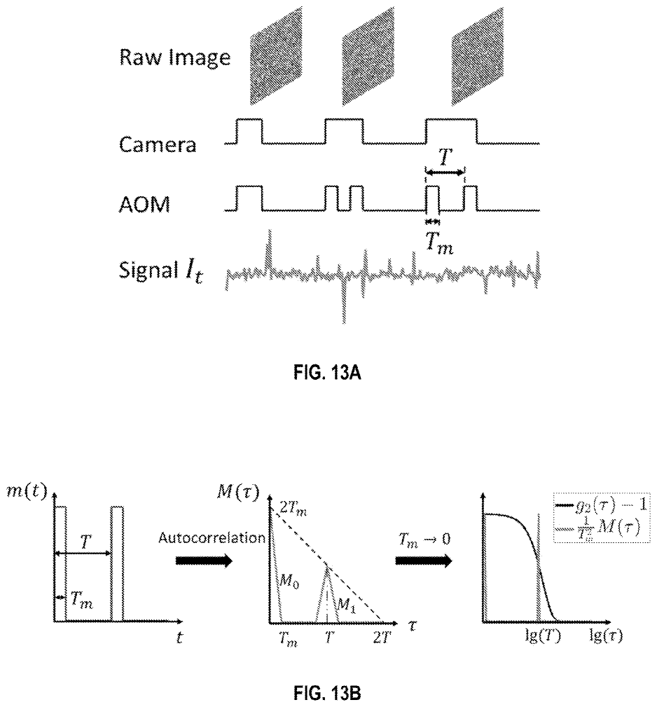

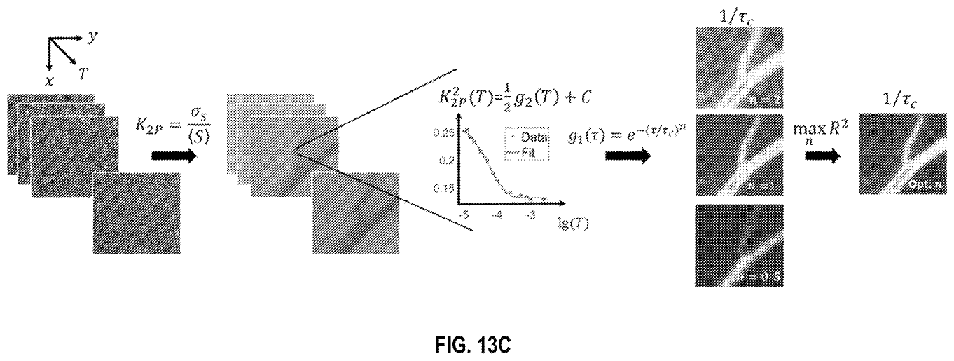

Referring now to FIGS. 13A-16B, in general, additional details regarding the disclosed within-exposure modulation technique, and related experimental results, are shown. The results described herein were obtained using an experimental setup similar to the configuration shown in FIG. 1B (e.g., system 150); however, it should be appreciated that these results more generally represent the feasibility of the disclosed within-exposure modulation technique on a variety of MESI systems, including system 100 and/or system 200, in some cases.

FIG. 13A illustrates a temporal relationship between intensity modulation and camera exposure. In this figure, the x-axis is time. The AOM line represents a voltage signal of an AOM (e.g., AOM 108) or other method for modulating the laser intensity. As shown, a target is illuminated only when AOM modulation voltage is high. Hence for It, only the signal when AOM is high will be recorded and integrated onto the camera raw image. FIG. 13B illustrates an autocorrelation function of a 2-pulse modulation waveform. The intensity modulation waveform, m(t), can be defined as m(t)∈[0,1]. The autocorrelation of m(t), defined as M(τ), consists of two pulses denoted as M₀ and M₁ in this illustration. When Tₘ is approaching zero, M(τ) becomes the sum of two delta functions. FIG. 13C illustrates a workflow for extracting correlation time from 2-pulse modulated multiple-exposure raw images. The 2-pulse modulated speckle contrast, K²_{2P}, is first computed from the modulated raw speckle images and its trace along the third dimension, T, is then fitted with different electric field autocorrelation g₁(τ) models (n=2, 1 or 0.5). The best g₁(τ) model is identified by maximizing the coefficient of determination, R².

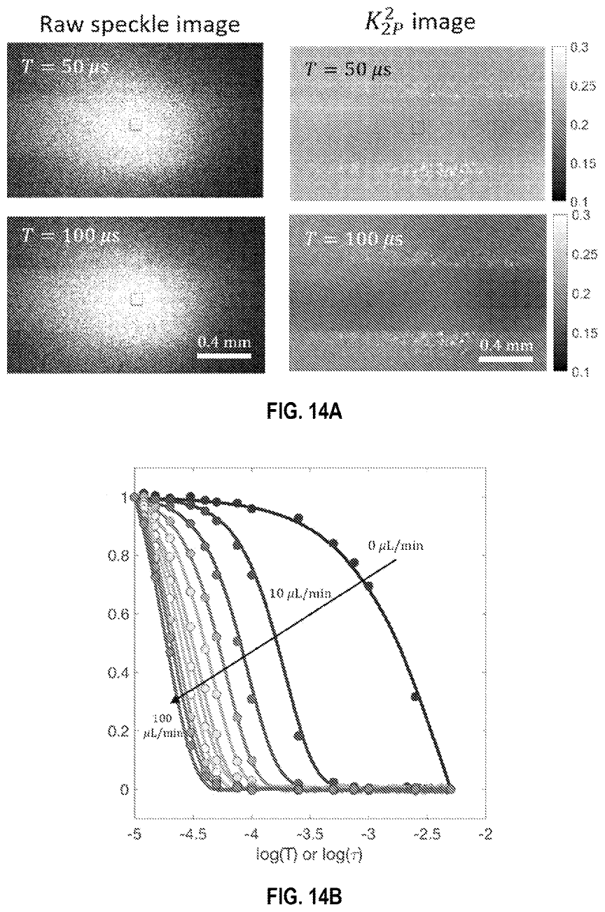

FIGS. 14A and 14B generally illustrate the experimental validation of the consistency between normalized K²_{2P} and g₂(τ) in flow phantoms. FIG. 14A includes images acquired in 2-pulse modulation approach (left side) and speckle contrast images calculated from 2-pulse modulated raw images (right side). FIG. 14B is a graph comparing measured normalized K²_{2P} (T) (denoted as dots) and measured g₂(τ) (denoted as solid lines) under flow rates ranging from 0 to 100 μL/min, in 10 μL/min steps.

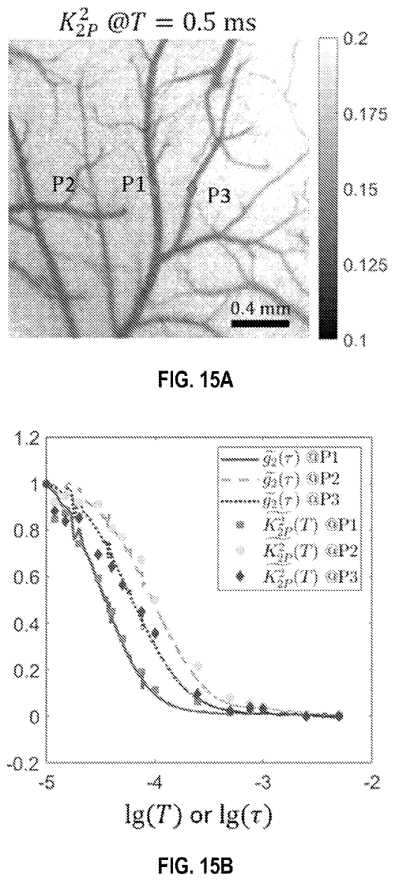

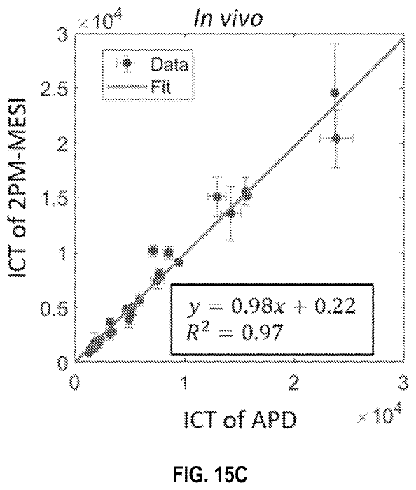

FIGS. 15A-15C generally illustrate the experimental validation of the consistency between normalized K²_{2P} and g₂(τ) in vivo in mouse brain. FIG. 15A is a speckle contrast image calculated from 2-pulse modulated raw image. FIG. 15B is a graph that compares measured normalized K²_{2P} (T) (denoted as dots) and g₂(τ) (denoted as solid lines) at three different spatial locations indicated by P1, P2, and P3, as in FIG. 15A. The tilde over the symbols in the legend indicated normalized quantities. FIG. 15C is a graph that compares the inverse correlation time (ICT) values extracted from the K²_{2P} and g₂(τ) in vivo, demonstrating excellent agreement between the two measurement types. 28 points from four mice are shown, in these example images.

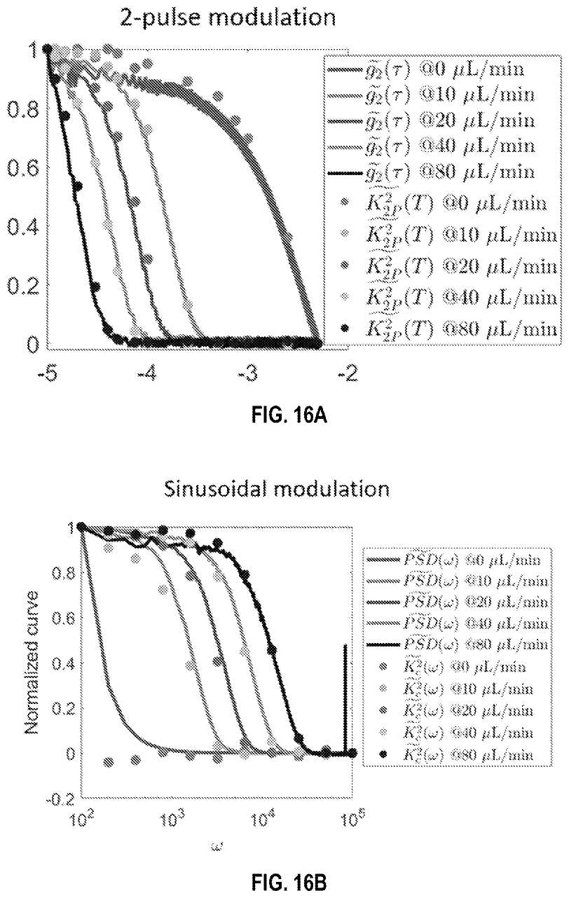

FIGS. 16A and 16B generally illustrate the experimental validation of sinusoidal modulation within an exposure in flow phantoms. FIG. 16A is a graph of normalized K²_{2P}(T) and g₂(τ) measured with 2-pulse modulation for flow rates ranging from 0 to 80 μL/min. FIG. 16B is a graph of measured K²_{c}(ω) (denoted as dots) and the normalized power spectral density (PSD) (denoted as solid lines) extracted from the single point intensity measurements for flow rates ranging from 0 to 80 μL/min. In this example ω represents the angular modulation frequency of the intensity of light within the camera exposure time, T (FIG. 11). The K²_{c}(ω) values match the PSD values as the modulation frequency, ω, is varied.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

### Example Implementations

Clause 1. An illumination system for laser speckle imaging, the illumination system comprising: a light source configured to output light having a wavelength ranging from 600 nm to 2000 nm; two or more sections of optical fiber; a fiber-coupled acousto-optic modulator (FCAOM), wherein the FCAOM is coupled to the light source by a first section of the two or more sections of optical fiber; and a collimating optic that focuses light output by the wavelength stabilized laser to illuminate a subject within a field of view (FOV), wherein the collimating optic is coupled to the FCAOM by a second section of the two or more sections of optical fiber.

Clause 2. The illumination system of clause 1, wherein the light source is a laser or laser diode.

Clause 3. The illumination system of clause 2, wherein the wavelength stabilized laser is a volume-holographic grating (VHG) stabilized laser diode.

Clause 4. The illumination system of any of clauses 1-3, wherein the collimating optic has an adjustable focal length.

Clause 5. The illumination system of any of clauses 1-4, wherein the first section of optical fiber comprises a first portion that is integrated with the light source and a second portion that is integrated with the FCAOM.

Clause 6. The illumination system of clause 5, wherein the first portion and the second portion are coupled by a mating sleeve.

Clause 7. The illumination system of any of clauses 1-6, wherein an image capture device is configured to capture images of the subject within the FOV when the FOV is illuminated by the light source.

Clause 8. The illumination system of clause 7, wherein the image capture device comprises at least one magnifying lens that magnifies the FOV.

Clause 9. The illumination system of clause 7, wherein the image capture device comprises a monochrome camera.

Clause 10. The illumination system of clause 9, wherein the image capture device comprises a long pass filter positioned between the FOV and the monochrome camera.

Clause 11. The illumination system of any of clauses 1-10, wherein the optical fiber is a single mode optical fiber.

Clause 12. The illumination system of any of clauses 1-11, wherein the collimating optic has an adjustable focal length.

Clause 13. The illumination system of any of clauses 1-12, further comprising a radiofrequency (RF) driver configured to modulate an output of the FCAOM.

Clause 14. The illumination system of clause 13, further comprising a controller configured to control the RF driver, wherein the controller synchronizes the output of the FCAOM with operation of an image capture system that captures images of the subject within the FOV.

Clause 15. A laser speckle imaging system comprising: a light source having an operating wavelength ranging from 600 nm to 2000 nm; an optical fiber; a fiber-coupled acousto-optic modulator (FCAOM), wherein the FCAOM is coupled to the light source by a first section of the optical fiber; a collimating optic that focuses light output by the light source to illuminate a field of view (FOV), wherein the collimating optic is coupled to the FCAOM by a second section of the optical fiber; and an image capture device for capturing images of the FOV when the FOV is illuminated by the light source.

Clause 16. The laser speckle imaging system of clause 15, wherein the light source is a laser or laser diode.

Clause 17. The laser speckle imaging system of clause 16, wherein the wavelength stabilized laser is a volume-holographic grating (VHG) stabilized laser diode.

Clause 18. The laser speckle imaging system of any of clauses 15-17, wherein the collimating optic has an adjustable focal length.

Clause 19. The laser speckle imaging system of any of clauses 15-18, wherein the first section of the optical fiber comprises a first portion that is integrated with the light source and a second portion that is integrated with the FCAOM.

Clause 20. The laser speckle imaging system of clause 19, wherein the first portion and the second portion are coupled by a mating sleeve.

Clause 21. The laser speckle imaging system of any of clauses 15-20, wherein the image capture device comprises at least one magnifying lens that magnifies the FOV.

Clause 22. The laser speckle imaging system of any of clauses 15-21, wherein the image capture device comprises a monochrome camera.

Clause 23. The laser speckle imaging system of clause 22, wherein the image capture device comprises a long pass filter positioned between the FOV and the monochrome camera.

Clause 24. The laser speckle imaging system of any of clauses 15-23, wherein the optical fiber is a single mode optical fiber.

Clause 25. The laser speckle imaging system of any of clauses 15-24, further comprising a radiofrequency (RF) driver configured to modulate an output of the FCAOM.

Clause 26. The laser speckle imaging system of clause 25, further comprising a controller configured to control the RF driver and the image capture device, wherein the controller synchronizes the capturing of images by the image capture device with the output of the FCAOM.

Clause 27. The laser speckle imaging system of clause 26, wherein the controller is further configured to: within a single exposure time of the image capture device: control the FCAOM to illuminate the FOV a plurality of different modulation frequencies; capture at least one image of the FOV at each of the plurality of different modulation frequencies; calculate a speckle contrast for each captured image to create one or more sets of speckle contrast images; and extract a value of an inverse correlation time at each pixel using the one or more sets of speckle contrast images.

Clause 28. The laser speckle imaging system of clause 26, wherein the controller is further configured to: control the FCAOM produce a first set of light pulses having a first time delay therebetween within a first exposure time of the image capture device; control the FCAOM produce a second set of light pulses having a second time delay therebetween within a second exposure time of the image capture device, wherein second time delay is different from the first time delay; capture a series of images of the FOV within each of the first and second exposure times; calculate a speckle contrast for each image of the series of images to create corresponding sets of speckle contrast images; and extract a value of an inverse correlation time at each pixel using the sets of speckle contrast images.

Clause 29. A method of speckle imaging comprising, within a single exposure time of a laser speckle imaging system: operating a light source and an acousto-optic modulator (AOM) of the laser speckle imaging system to illuminate a field of view (FOV) at a plurality of different modulation frequencies; capturing at least one image of the FOV at each of the plurality of different modulation frequencies; calculating a speckle contrast for each captured image to create one or more sets of speckle contrast images; and extracting a value of inverse correlation time at each pixel using the one or more sets of speckle contrast images.

Clause 30. The method of clause 29, wherein operating the light and the AOM to illuminate the FOV at the plurality of different modulation frequencies comprises controlling the AOM to adjust a modulation frequency of light directed to the FOV according to the plurality of different modulation frequencies.

Clause 31. The method of clause 29, wherein operating the light source and the AOM to illuminate the FOV at the plurality of different modulation frequencies comprises controlling the light source to adjust a modulation frequency of light directed to the FOV according to the plurality of different modulation frequencies.

Clause 32. The method of any of clauses 29-31, wherein the AOM is a fiber-coupled AOM.

Clause 33. The method of any of clauses 29-32, further comprising determining blood flow from the value of inverse correlation time at each pixel.

Clause 34. The method of any of clauses 29-33, wherein the light source of the laser speckle imaging system is a laser or laser diode.

Clause 35. The method of clause 34, wherein the light source has an operating wavelength of ranging from 600 nm to 2000 nm.

Clause 36. The method of clause 34, wherein the wavelength stabilized laser is a fiber-coupled volume-holographic grating (VHG) stabilized laser diode.

Clause 37. The method of any of clauses 29-36, wherein the light source is coupled to the AOM via a section of optical fiber.

Clause 38. The method of any of clauses 29-37, wherein the AOM is coupled to an adjustable focal length collimating optic via a section of optical fiber, wherein the adjustable focal length collimating optic that focuses the light output by the light source to illuminate the FOV.

Clause 39. The method of any of clauses 29-38, wherein the laser speckle imaging system comprises an image capture device for capturing the at least one image of the FOV, wherein the image capture device comprises a monochrome camera and at least one magnifying lens.

Clause 40. The method of clause 39, wherein the image capture device further comprises a long pass filter positioned between the FOV and the monochrome camera.

Clause 41. The method of any of clauses 29-40, wherein operating the AOM comprises transmitting commands to a radiofrequency (RF) driver of the laser speckle imaging system, wherein the RF driver is coupled to the AOM.

Clause 42. A method of speckle imaging comprising: operating a light source and acousto-optic modulator (AOM) of a laser speckle imaging system to produce a first set of pulses having a first time delay therebetween within a first exposure time of the laser speckle imaging system, wherein light output by the light source illuminates a field of view (FOV); operating the light source and the AOM to produce a second set of pulses having a second time delay therebetween within a second exposure time of the laser speckle imaging system, wherein second time delay is different from the first time delay; capturing a series of images of the FOV within each of the first and second exposure times; calculating a speckle contrast for each image of the series of images to create corresponding sets of speckle contrast images; and extracting a value of inverse correlation time at each pixel using the sets of speckle contrast images.

Clause 43. The method of clause 42, further comprising determining blood flow from the value of inverse correlation time at each pixel.

Clause 44. The method of clause 42 or 43, wherein the light source of the laser speckle imaging system is a laser or laser diode.

Clause 45. The method of clause 44, wherein the light source has an operating wavelength ranging from 600 nm to 2000 nm.

Clause 46. The method of clause 44, wherein the wavelength stabilized laser is a fiber-coupled volume-holographic grating (VHG) stabilized laser diode.

Clause 47. The method of any of clauses 42-46, wherein the light source is coupled to the AOM via a section of optical fiber.

Clause 48. The method of any of clauses 42-47, wherein the AOM is coupled to an adjustable focal length collimating optic via a section of optical fiber, wherein the adjustable focal length collimating optic that focuses the light output by the light source to illuminate the FOV.

Clause 49. The method of any of clauses 42-48, wherein the laser speckle imaging system comprises an image capture device for capturing the series of images of the FOV, wherein the image capture device comprises a monochrome camera and at least one magnifying lens.

Clause 50. The method of clause 49, wherein the image capture device further comprises a long pass filter positioned between the FOV and the monochrome camera.

Clause 51. The method of any of clauses 42-50, wherein controlling the AOM comprises transmitting commands to a radiofrequency (RF) driver of the laser speckle imaging system, wherein the RF driver is coupled to the AOM.

Clause 52. The method of any of clauses 42-51, wherein the AOM is a fiber-coupled AOM.

1. An illumination system for laser speckle imaging, the illumination system comprising:
a light source configured to output light having a wavelength ranging from 600 nm to 2000 nm;
two or more sections of optical fiber;
a fiber-coupled acousto-optic modulator (FCAOM), wherein the FCAOM is coupled to the light source by a first section of the two or more sections of optical fiber; and
a collimating optic that focuses light output by the wavelength stabilized laser to illuminate a subject within a field of view (FOV), wherein the collimating optic is coupled to the FCAOM by a second section of the two or more sections of optical fiber.

2. (canceled)

3. The illumination system of claim 1, wherein the wavelength stabilized laser is a volume-holographic grating (VHG) stabilized laser diode.

4. The illumination system of claim 1, wherein the collimating optic has an adjustable focal length.

5. The illumination system of claim 1, wherein the first section of optical fiber comprises a first portion that is integrated with the light source and a second portion that is integrated with the FCAOM.

6. (canceled)

7. The illumination system of claim 1, wherein an image capture device is configured to capture images of the subject within the FOV when the FOV is illuminated by the light source.

8. The illumination system of claim 7, wherein the image capture device comprises at least one magnifying lens that magnifies the FOV.

9. The illumination system of claim 7, wherein the image capture device comprises a monochrome camera, and wherein the image capture device comprises a long pass filter positioned between the FOV and the monochrome camera.

10. (canceled)

11. The illumination system of claim 1, wherein the optical fiber is a single mode optical fiber.

12. The illumination system of claim 1, wherein the collimating optic has an adjustable focal length.

13. The illumination system of claim 1, further comprising a radiofrequency (RF) driver configured to modulate an output of the FCAOM.

14. The illumination system of claim 13, further comprising a controller configured to control the RF driver, wherein the controller synchronizes the output of the FCAOM with operation of an image capture system that captures images of the subject within the FOV.

15. A laser speckle imaging system comprising:
a light source having an operating wavelength ranging from 600 nm to 2000 nm;
an optical fiber;
a fiber-coupled acousto-optic modulator (FCAOM), wherein the FCAOM is coupled to the light source by a first section of the optical fiber;
a collimating optic that focuses light output by the light source to illuminate a field of view (FOV), wherein the collimating optic is coupled to the FCAOM by a second section of the optical fiber; and
an image capture device for capturing images of the FOV when the FOV is illuminated by the light source.

16. (canceled)

17. The laser speckle imaging system of claim 15, wherein the wavelength stabilized laser is a volume-holographic grating (VHG) stabilized laser diode, and wherein the collimating optic has an adjustable focal length.

18. (canceled)

19. The laser speckle imaging system of claim 15, wherein the first section of the optical fiber comprises a first portion that is integrated with the light source and a second portion that is integrated with the FCAOM.

20. (canceled)

21. The laser speckle imaging system of claim 15, wherein the image capture device comprises at least one magnifying lens that magnifies the FOV.

22. The laser speckle imaging system of claim 15, wherein the image capture device comprises a monochrome camera and a long pass filter positioned between the FOV and the monochrome camera.

23. (canceled)

24. (canceled)

25. The laser speckle imaging system of claim 15, further comprising a radiofrequency (RF) driver configured to modulate an output of the FCAOM.

26. The laser speckle imaging system of claim 25, further comprising a controller configured to control the RF driver and the image capture device, wherein the controller synchronizes the capturing of images by the image capture device with the output of the FCAOM.

27. The laser speckle imaging system of claim 26, wherein the controller is further configured to:
within a single exposure time of the image capture device:
control the FCAOM to illuminate the FOV a plurality of different modulation frequencies;
capture at least one image of the FOV at each of the plurality of different modulation frequencies;
calculate a speckle contrast for each captured image to create one or more sets of speckle contrast images; and
extract a value of an inverse correlation time at each pixel using the one or more sets of speckle contrast images.

28. The laser speckle imaging system of claim 26, wherein the controller is further configured to:
control the FCAOM produce a first set of light pulses having a first time delay therebetween within a first exposure time of the image capture device;
control the FCAOM produce a second set of light pulses having a second time delay therebetween within a second exposure time of the image capture device, wherein second time delay is different from the first time delay;
capture a series of images of the FOV within each of the first and second exposure times;
calculate a speckle contrast for each image of the series of images to create corresponding sets of speckle contrast images; and
extract a value of an inverse correlation time at each pixel using the sets of speckle contrast images.

29-54. (canceled)
